(19) United States
(12) Patent Application Publication
(10) Pub. No.: US 2014/0267467 A1
(43) Pub. Date: Sep. 18, 2014

(54) DISPLAY APPARATUS AND DRIVING METHOD FOR DISPLAY PANEL THEREOF

(71) Applicant: Chunghwa Picture Tubes, LTD., Taoyuan (TW)

(72) Inventors: Yi-Jui Huang, Taoyuan County (TW); Chiao-Lin Huang, New Taipei City (TW)

(21) Appl. No.: 13/896,348

(22) Filed: May 17, 2013

(30) Foreign Application Priority Data
Mar. 18, 2013 (TW) 102109533

(51) Int. Cl. G09G 3/36

(52) U.S. Cl. CPC G09G 3/3607
USPC 345/691; 345/89

(57) ABSTRACT

A display apparatus and a driving method for the display panel thereof are provided. The timing controller of the display apparatus determines whether the frame-displaying signal is a specific frame for displaying a first gray-level value and a second gray-level value. When the frame-displaying signal is corresponding to a specific frame for displaying the first gray-level value and the second gray-level value, the timing controller adjusts a plurality of enabling durations of multiple scan signals to control the pixels displaying the same luminance; when the frame-displaying signal is not corresponding to the specific frame for displaying the first gray-level value and the second gray-level value, the timing controller adjusts the enabling time of the scan signals to be identical to each other.

### CROSS-REFERENCE TO RELATED APPLICATION

This application claims the priority benefit of Taiwan application no. 102109533, filed on Mar. 18, 2013. The entirety of the above-mentioned patent application is hereby incorporated by reference herein and made a part of this specification.

### BACKGROUND OF THE INVENTION

1. Field of the Invention

The invention generally relates to a display apparatus and a driving method for the display panel thereof, and more particularly, to a liquid crystal display (LCD) and a driving method for the LCD panel thereof.

2. Description of Related Art

With the tremendous progress in photoelectric technology and semiconductor devices, flat panel display such as LCD has been rapidly developed and applied to a variety of electronic products. The many advantages of LCD, such as low power consumption, no radiation and high space utilization, make the LCD become mainstream products on the market.

In addition, with the advances of the image quality or the display device performance, the display panel layout gains continuous improvement. However, in the case of changing the layout of the display panel, the driving way of the display panel gets varied as well, so that during displaying certain special frames, the charging effect of the pixels on a display panel may be different. As a result, part of the pixels has bright-shifted or dim-shifted situation, which causes uneven bright lines and dim lines or bright spots and dim spots.

### SUMMARY OF THE INVENTION

Accordingly, the invention is directed to a display apparatus and a driving method for the display panel thereof, which can eliminate the bright lines and dim lines on certain specific frames displayed by the display panel in the display apparatus.

The display apparatus of the invention includes a timing controller, a source driver, a scan driver and a display panel. The timing controller receives a frame-displaying signal. The source driver is coupled to the timing controller to provide a plurality of pixel voltages. The scan driver is coupled to the timing controller to provide a plurality of scan signals. The display panel includes a plurality of data lines, a plurality of scan lines and a plurality of pixels. The data lines are coupled to the source driver to respectively receive the pixel voltages. The scan lines are coupled to the scan driver to respectively receive the scan signals. The pixels are respectively coupled to the corresponding data line and the corresponding scan line so as to receive the corresponding pixel voltage and the corresponding scan signal, wherein the data line coupled to each of the pixels is different from the data lines coupled to the adjacent pixels. When the timing controller determines out the frame-displaying signal divides the pixels into a plurality of groups respectively for displaying in a first gray-level value and a second gray-level value, the scan driver, controlled by the timing controller, adjusts a plurality of enabling durations of the scan signals so as to control the pixels of each of the groups displaying the same luminance, wherein each of the groups comprises at least two of the pixels.

In the driving method for a display panel of the invention, the display panel includes a plurality of data lines, a plurality of scan lines and a plurality of pixels, the pixels are respectively coupled to corresponding data line and corresponding scan line to receive the corresponding pixel voltage in a plurality of pixel voltages and the corresponding scan signal in a plurality of scan signals, the data line coupled to each pixel is different from the data lines coupled to the adjacent pixels, and the driving method includes following steps: receiving a frame-displaying signal; determining whether the frame-displaying signal divides the pixels into a plurality of groups to respectively display a first gray-level value and a second gray-level value by a timing controller of a display apparatus; when the timing controller determines out the frame-displaying signal divides the pixels into a plurality of groups for respectively displaying a first gray-level value and a second gray-level value, the timing controller adjusts a plurality of enabling durations of the scan signals so as to control the pixels of each of the groups displaying the same luminance, wherein each of the groups includes at least two of the pixels; and when the timing controller determines out the frame-displaying signal does not divide the pixels into a plurality of groups for respectively displaying a first gray-level value and a second gray-level value, the timing controller adjusts the enabling durations of the scan signals identical to each other.

Based on the description above, in the display apparatus and the driving method for a display panel thereof in the embodiments of the invention, the timing controller can determine whether the frame-displaying signal is displaying a specific frame, and accordingly, can decide whether adjust the enabling durations of the scan signals to eliminate the luminance differences displayed by the pixels. As a result, the invention can eliminated the bright lines and dim lines caused by displaying a specific frame by the display panel of a display apparatus to improve the displaying quality of the display apparatus.

In order to make the features and advantages of the present invention more comprehensible, the present invention is further described in detail in the following with reference to the embodiments and the accompanying drawings.

### BRIEF DESCRIPTION OF THE DRAWINGS

FIG. 1 is a schematic system diagram of a display apparatus according to an embodiment of the invention.

FIG. 2A is a frame diagram transmitted by a frame-displaying signal according to an embodiment of the invention.

FIG. 2B is a driving waveform diagram of a display apparatus according to an embodiment of the invention.

FIG. 3A is a frame diagram transmitted by a frame-displaying signal according to another embodiment of the invention.

FIG. 3B is a driving waveform diagram of a display apparatus according to another embodiment of the invention.

FIG. 4 is a flowchart of the driving method for a display panel according to an embodiment of the invention.

### DESCRIPTION OF THE EMBODIMENTS

FIG. 1 is a schematic system diagram of a display apparatus according to an embodiment of the invention. Referring to FIG. 1, in the embodiment, a display apparatus 100 includes a timing controller 110, a source driver 120, a scan driver 130 and a display panel 140. The timing controller 110 receives a frame-displaying signal FDP and is coupled to the source driver 120 and the scan driver 130. The timing controller 110 provides a display data DDP to the source driver 120 according to the received frame-displaying signal FDP and provides an output enabling signal OE to the scan driver according to the timing of the received frame-displaying signal FDP. The source driver 120 receives the display data DDP provided by the timing controller 110 so as to provide a plurality of pixel voltages VP1-VPn to the display panel 140, wherein n is an integer greater. The scan driver 130 receives the output enabling signal OE provided by the timing controller 110 so as to provide a plurality of scan signals G1-Gm to the display panel 140, wherein m is an integer greater. The scan driver 130 determines the enabling duration of each of the scan signals G1-Gm according to the output enabling signal OE.

The display panel 140 includes a plurality of data lines 141_1-141_{—}n, a plurality of scan lines 143_1-143_{—}m, and a plurality of pixels 145 and receives a common voltage Vcom. The data lines 141_1-141_{—}n are coupled to the source driver 120 to respectively receive the pixel voltages VP1-VPn, for example, the data line 141_1 receives the pixel voltage VP1, the data line 141_2 receives the pixel voltage VP2, and the rest can be deduced by analogy. The scan lines 143_1-143_{—}m are coupled to the scan driver 130 to respectively receive the scan signals G1-Gm, for example, the scan line 143_1 receives the scan signal G1, the scan line 143_2 receives the scan signal G2, and the rest can be deduced by analogy.

The pixels 145 are arranged in an array and respectively coupled to the corresponding data line (for example, 141_1-141_{—}n) and the corresponding scan line (for example, 143_1-143_{—}m) so as to receive the corresponding pixel voltage (for example, VP1-VPn) and the corresponding scan signal (for example, G1-Gm), in which the data line (for example, 141_1-141_{—}n) coupled to each pixel 145 is different from the data lines (for example, 141_1-141_{—}n) coupled to the adjacent pixels 145. In other words, each data line (for example, 141_1-141_{—}n) and the coupled pixels 145 are shown in z-shape structure, i.e., the data line (for example, 141_1-141_{—}n) coupled to each pixel 145 is different from the data lines (for example, 141_1-141_{—}n) coupled to the horizontally adjacent pixels 145 and different from the data line (for example, 141_1-141_{—}n) coupled to the vertically adjacent pixels 145. The horizontal and the vertical terms herein are based on the figures, which the invention is not limited to. The pixels 145 within a display region ADP give displaying by using the corresponding frame-displaying signal FDP, while the pixels 145 out of the display region ADP do not have displaying effect and are hidden from the user, i.e., the pixels 145 out of the display region ADP do not contribute the displaying effect of the display apparatus 100 so that their displaying effect can be ignored.

In the embodiment, the timing controller 110 can determine whether the frame-displaying signal FDP divides the pixels 145 on the display panel 140 into a plurality of groups for respectively displaying the first gray-level value and the second gray-level value, in which the first gray-level value and the second gray-level value are, for example, the maximum gray-level value and the minimum gray-level value. In terms of a gray-level value range 0-255, the maximum gray-level value can be one of the gray-level values 224-255 and the minimum gray-level value can be one of the gray-level values range 0-31.

When the timing controller 110 determines out the frame-displaying signal FDP does not divide the pixels 145 on the display panel 140 into a plurality of groups for respectively displaying the first gray-level value and the second gray-level value, the scan driver 130, controlled by the output enabling signal OE provided by the timing controller 110, sets the enabling durations of the scan signals G1-Gm as the identical durations to each other; when the timing controller 110 determines out the frame-displaying signal FDP divides the pixels 145 on the display panel 140 into a plurality of groups for respectively displaying the first gray-level value and the second gray-level value (i.e., the display panel 140 displays a certain specific frame), the scan driver 130, controlled by the output enabling signal OE provided by the timing controller 110, adjusts the enabling durations of the scan signals G1-Gm so as to make the pixels 145 of each group display a same luminance by control. The each group herein includes at least two pixels 145. In this way, when the frame-displaying signal FDP divides the pixels 145 on the display panel 140 into a plurality of groups for respectively displaying the first gray-level value and the second gray-level value, the probability to produce bright lines and dim lines with the display panel 140 can be reduced or eliminated.

FIG. 2A is a frame diagram transmitted by a frame-displaying signal according to an embodiment of the invention and FIG. 2B is a driving waveform diagram of a display apparatus according to an embodiment of the invention. Referring to FIGS. 1, 2A and 2B, in the embodiment, the pixels 145 of the display panel 140 are divided into a plurality of groups 210 and 220, in which each of the groups 210 and 220 includes one column of pixels 145, where, i.e., one column of pixels comprises a group 210 or 220; and assuming the pixels 145 of the group 210 display the minimum gray-level value GL, the pixels 145 of the group 220 display the maximum gray-level value GH and the groups 210 and 220 are alternately disposed along the horizontal direction shown by the figure.

In other words, in the embodiment, the groups 210 and 220 respectively include identical quantity and identical arrangement of the pixels 145; every group 210 is adjacent to groups 220, rather than to groups 210; every group 220 is adjacent to groups 210, rather than to groups 220. The difference between the minimum gray-level value GL and the common voltage Vcom herein is assumed to be the minimum, and the difference between the maximum gray-level value GH and the common voltage Vcom herein is assumed to be the maximum. The above-mentioned assumption is an example for description convenience, which the embodiment of the invention is not limited to.

In the embodiment, the source driver 120 takes a column inversion mode to output the pixel voltages VP1-VPn, i.e., the polarity of each pixel voltage (for example, VP1-VPn) is different from the polarity of the adjacent pixel voltages (for example, VP1-VPn), for example, the polarity of the pixel voltage VP2 is different from the polarities of the pixel voltages VP1 and VP3, and the rest can be deduced by analogy, wherein the polarity of the pixel voltage (for example, VP1-VPn) is determined out based on the common voltage Vcom.

Since the data lines 141_1-141_{—}n and the pixels 145 of the display panel 140 are coupled to each other shown in z-shape structure, the displaying effect of the display panel 140 is the same as the effect in dot inversion driving mode, and at the time, the pixel voltages VP2-VPn−1 are ceaselessly alternated between the maximum gray-level value GH and the minimum gray-level value GL. When the plurality of durations (for example, P1-P5) for the output enabling signal OE to be low voltage level are the same as each other, the plurality of enabling durations (for example, EP1-EP5) of all the scan signals (for example, G1-G5) are the same as each other. Since the enabling durations (for example, EP1-EP5) of all the scan signals (for example, G1-G5) decide the charging time of the pixels 145 in the corresponding horizontal scanning durations, the same enabling durations (for example, EP1-EP5) of the scan signals (for example, G1-G5) means the charging time of the pixel 145 in every horizontal scanning duration is the identical to each other, in which the pixel voltages VP2-VPn−1 are ceaselessly alternated between the maximum gray-level value GH or the minimum gray-level value GL whenever switching the horizontal scanning duration from one to the next.

As shown by FIG. 2B, the pixel voltages VP2-VPn−1 keep the same voltage level (i.e., the DC level) in the enabling duration EP1 of the scan signal G1(i.e., the charging duration of the first horizontal scanning duration), while the voltage levels of the pixel voltages VP2-VPn−1 in the enabling durations (for example, EP2-EP5) of other scan signals (for example, G2-G5) include partial transient voltages (for example, as shown by VT1). When the charging time of every horizontal scanning duration is the identical to each other, the maximum gray-level value GH of the pixel 145 coupled to the scan line 143_1 is higher than the maximum gray-level value GH of the pixel 145 coupled to other scan lines (for example, 143_2-143_{—}m). At the time, the maximum gray-level values GH of the pixels 145 of every group 220 may be different from each other (i.e., the charging effects of the pixels 145 are different from each other or the cross-voltages at the two terminals of the pixels 145 are different from each other), which affects the displaying effect.

According to the description above, the embodiment take such a scheme of lowering down the luminance displayed by the pixel 145 coupled to the scan line 143_1 corresponding to the maximum gray-level value GH; at the time, the timing controller 110 would shorten the duration P1 for low voltage level in the output enabling signal OE corresponding to the enabling duration EP1 of the scan signal G1(i.e., corresponding to the first horizontal scanning duration in a frame duration). In other words, when the timing controller 110 determines out the frame-displaying signal FDP takes a column of pixels as a group (for example, 210 or 220) for respectively displaying maximum gray-level value GH and the minimum gray-level value GL, the timing controller 110 shortens the enabling duration EP1 of the scan signal G1 corresponding to the first scanning duration so that the pixels 145 of each group (for example, 210 or 220) display the same luminance.

In other embodiments, it can increase up the luminance of the pixels coupled to the scan lines 143_2-143_{—}m corresponding to the maximum gray-level value GH; at the time, the timing controller 110 elongates the durations (for example, P2-P5) for low voltage level in the output enabling signal OE not corresponding to the enabling duration EP1 of the scan signal G1. In other words, when determining the frame-displaying signal FDP takes a column of pixels as a group (for example, 210 or 220) for respectively displaying the maximum gray-level value GH and the minimum gray-level value GL, and the voltage levels of the pixel voltages VP2-VPn−1 in a horizontal scanning duration are different from the voltage levels of the pixel voltages VP2-VPn−1 in the previous horizontal scanning duration, the timing controller 110 elongates the enabling duration (for example, EP2-EP5) of the scan signal (for example, scan signals G2-G5) corresponding to the present horizontal scanning duration so that the pixels 145 of each group (for example, 210 or 220) display the same luminance.

The shortened or elongated time length of the durations P1-P5 for low voltage level of the output enabling signal OE depends on the luminance difference of the pixels 145 of each group (for example, 210 or 220); or the timing controller 110 can gradually shorten the enabling duration EP1 of the scan signal G1 corresponding to the first enabling duration and/or gradually elongate the enabling durations (for example, EP2-EP5) of the scan signal (for example, G2-G5) not corresponding to the first enabling duration until the pixels 145 of each group (for example, 210 or 220) display the same luminance.

FIG. 3A is a frame diagram transmitted by a frame-displaying signal according to another embodiment of the invention and FIG. 3B is a driving waveform diagram of a display apparatus according to another embodiment of the invention. Referring to FIGS. 1, 2A, 2B, 3A and 3B, in the embodiment, the pixels 145 of the display panel 140 are divided into a plurality of groups 310 and 320, in which each of the groups 310 and 320 includes two pixels 145 of the same column, i.e., two pixels 145 of the same column serve as a group 310 or 320. Assuming the pixels 145 of the group 310 display the minimum gray-level value GL, the pixels 145 of the group 320 display the maximum gray-level value GH, and the groups 310 and 320 are disposed in chessboard shape.

In other words, in the embodiment, the groups 310 and 320 respectively include identical quantity and identical arrangement of the pixels 145; every group 310 is adjacent to groups 320, rather than to groups 310; every group 320 is adjacent to groups 310, rather than to groups 320. The source driver 120 takes a column inversion mode to output the pixel voltages VP1-VPn, in which the setting of the minimum gray-level value GL and the maximum gray-level value GH of the pixel voltages VP1-VPn is the same as the above-mentioned embodiment, which is omitted to describe. The pixel voltages VP2-VPn−1 alternately switch the voltage level thereof to be the maximum gray-level value GH or the minimum gray-level value GL every two horizontal scanning durations after the first horizontal scanning duration.

As shown by FIG. 3B, the pixel voltages VP2-VPn−1 keep the same voltage level (i.e., the DC level) in the enabling durations EP1, EP3 and EP5 of the scan signals G1, G3 and G5(i.e., the charging durations of the first, the third and the fifth horizontal scanning duration), while the voltage levels of the pixel voltages VP2-VPn−1 in the enabling durations (for example, EP2 and EP4, i.e., the charging time of other horizontal scanning durations) of other scan signals (for example, G2 and G4) include partial transient voltages (for example, as shown by VT2). When the charging time of every horizontal scanning duration is the identical to each other, the maximum gray-level value GH of the pixel 145 coupled to the odd scan lines (for example, 143_1, 143_3 and so on) is higher than the maximum gray-level value GH of the pixel 145 coupled to other even scan lines (for example, 143_2, 143_4 and so on). At the time, the maximum gray-level values GH of the pixels 145 of every group 320 may be the different from each other to affect the displaying effect.

According to the description above, the embodiment take such a scheme of lowering down the luminance displayed by the pixel 145 coupled to the odd (for example, 143_1, 143_3 and so on) corresponding to the maximum gray-level value GH; at the time, the timing controller 110 would shorten the duration (for example, P1, P3 and so on) for low voltage level in the output enabling signal OE corresponding to the enabling durations (for example, EP1, EP3 and so on) of the odd scan signals (for example, G1, G3 and so on). In other words, when the timing controller 110 determines out the frame-displaying signal FDP takes the two pixels of a same column as a group (for example, 310 or 320) for respectively displaying maximum gray-level value GH and the minimum gray-level value GL, and the voltage levels of the pixel voltages VP2-VPn−1 in a horizontal scanning duration are the same as the voltage levels of the pixel voltages VP2-VPn−1 in the previous horizontal scanning duration or the horizontal scanning duration is the first horizontal scanning duration of the frame duration, the timing controller 110 shortens the enabling durations (for example, EP1, EP3 and EP5) of the scan signals (for example, G1, G3 and G5) corresponding to the horizontal scanning duration so that the pixels 145 of each group (for example, 310 or 320) display the same luminance.

In other embodiments, the timing controller 110 can increase up the luminance of the pixels coupled to the even scan lines (for example, 143_2, 143_4 and so on) corresponding to the maximum gray-level value GH; at the time, the timing controller 110 elongates the durations (for example, P2, P4 and so on) for low voltage level in the output enabling signal OE corresponding to the enabling durations (for example, EP2, EP4 and so on) of the even scan signals (for example, G2, G4 and so on). In other words, when the timing controller 110 determines out the frame-displaying signal FDP takes two pixels of a same column as a group (for example, 310 or 320) for respectively displaying the maximum gray-level value GH and the minimum gray-level value GL, and the voltage levels of the pixel voltages VP2-VPn−1 in a horizontal scanning duration are different from the voltage levels of the pixel voltages VP2-VPn−1 in the previous horizontal scanning duration, the timing controller 110 elongates the enabling duration (for example, EP2 and EP4) of the scan signals (for example, scan signals G2 and G4) corresponding to the present horizontal scanning duration so that the pixels 145 of each group (for example, 310 or 320) display the same luminance.

The shortened or elongated length of the durations of low voltage level P1-P5 of the output enabling signal OE depends on the luminance difference of the pixels 145 of each group (for example, 310 or 320); or the timing controller 110 can gradually shorten the enabling durations (for example, EP1, EP3 and so on) of the scan signals (for example, G1, G3 and so on) corresponding to the odd horizontal scanning durations and/or gradually elongate the enabling durations (for example, EP2, EP4 and so on) of the scan signals (for example, G2, G4 and so on) corresponding to the even horizontal scanning durations until the pixels 145 of each group (for example, 310 or 320) display the same luminance.

In some embodiments, the frame-displaying signal FDP may take the three or more pixels of a same column as a group for respectively displaying maximum gray-level value GH and the minimum gray-level value GL. According to the description of the above-mentioned embodiments, when the frame-displaying signal FDP takes the three pixels of a same column as a group for respectively displaying maximum gray-level value GH and the minimum gray-level value GL, the timing controller 110 can shorten the enabling durations (for example, EP1, EP4 and so on) of the scan signals (for example, G1, G4 and so on) corresponding to the (3i+1)-th horizontal scanning duration and/or gradually elongate the enabling durations (for example, EP2, EP3, EP5 and so on) of the scan signals (for example, G2, G3, G5 and so on) not corresponding to the (3i+1)-th horizontal scanning duration so that the pixels 145 of each group display the same luminance, wherein i is an integer greater than or equal to 0. The other embodiments of the invention can refer to above-mentioned embodiments to get deduction, which is omitted to describe.

FIG. 4 is a flowchart of the driving method for a display panel according to an embodiment of the invention. Referring to FIG. 4, the embodiment is suitable for the display panel 140 in FIG. 1. The driving method for a display panel includes following steps: receiving a frame-displaying signal (step S410), and determining whether the frame-displaying signal divides the pixels into a plurality of groups to respectively display a first gray-level value and a second gray-level value by a timing controller of a display apparatus (step S410); when the timing controller determines out the frame-displaying signal divides the pixels into a plurality of groups for respectively displaying a first gray-level value and a second gray-level value, i.e., the determining result of step S420 is “YES”, adjusting a plurality of enabling durations of the scan signals by the timing controller so as to control the pixels of each of the groups displaying the same luminance (step S430), wherein each of the groups comprises at least two of the pixels.

When the timing controller determines out the frame-displaying signal does not divide the pixels into a plurality of groups for respectively displaying a first gray-level value and a second gray-level value, i.e., the determining result of step S420 is “NO”, the timing controller adjusts the enabling durations of the scan signals identical to each other by the timing controller (step S440). The sequence of the above-mentioned steps herein are an example only, which the invention is not limited to. The details of the above-mentioned steps can refer to the embodiments of FIGS. 1, 2A, 2B, 3A and 3B, which are omitted to describe.

In summary, in the display apparatus and the driving method for a display panel thereof in the embodiments of the invention, the timing controller can determine whether the frame-displaying signal is displaying a specific frame, and accordingly, can thereby decide whether needing to adjust the enabling durations of the scan signals to eliminate the luminance differences displayed by the pixels. As a result, the invention can eliminate the bright lines and dim lines caused by a specific frame displayed by the display panel of a display apparatus so as to improve the displaying quality of the display apparatus.

What is claimed is:

1. A display apparatus, comprising:
a timing controller, receiving a frame-displaying signal;
a source driver, coupled to the timing controller to provide a plurality of pixel voltages;
a scan driver, coupled to the timing controller to provide a plurality of scan signals; and
a display panel, comprising:
a plurality of data lines, coupled to the source driver to respectively receive the pixel voltages;
a plurality of scan lines, coupled to the scan driver to respectively receive the scan signals; and
a plurality of pixels, respectively coupled to the corresponding data line and the corresponding scan line to receive the corresponding pixel voltage and the corresponding scan signal, wherein the data line coupled to each of the pixels is different from the data line coupled to the adjacent pixels;
wherein the scan driver, controlled by the timing controller, adjusts a plurality of enabling durations of the scan signals to control the pixels of each of the groups displaying the same luminance, wherein each of the groups comprises at least two of the pixels when the timing controller determines out the frame-displaying signal divides the pixels into a plurality of groups respectively for displaying a first gray-level value and a second gray-level value.

2. The display apparatus as claimed in claim 1, wherein the source driver outputs the pixel voltages in a column inversion mode.

3. The display apparatus as claimed in claim 2, wherein the scan driver controlled by the timing controller elongates enabling duration of scan signal corresponding to the horizontal scanning duration when voltage level of the pixel voltages in a horizontal scanning duration is different from voltage level of the pixel voltages in the previous horizontal scanning duration.

4. The display apparatus as claimed in claim 2, wherein the scan driver controlled by the timing controller shortens enabling duration of scan signal corresponding to the horizontal scanning duration when voltage level of the pixel voltages in a horizontal scanning duration is the same as voltage level of the pixel voltages in the previous horizontal scanning duration or the horizontal scanning duration is the first horizontal scanning duration of one frame duration.

5. The display apparatus as claimed in claim 1, wherein the first gray-level value and the second gray-level value are respectively a maximum gray-level value and a minimum gray-level value.

6. The display apparatus as claimed in claim 1, wherein pixel quantities and arrangements of the pixels respectively comprised by the groups are identical.

7. The display apparatus as claimed in claim 1, wherein the groups adjacent to the each of the groups display the second gray-level value when each of the groups displays the first gray-level value.

8. The display apparatus as claimed in claim 1, wherein the scan driver controlled by an output enabling signal provided by the timing controller to adjust the enabling durations of the scan signals.

9. A driving method for a display panel, wherein the display panel comprises a plurality of data lines, a plurality of scan lines and a plurality of pixels, the pixels are respectively coupled to corresponding data line and corresponding scan line to receive corresponding pixel voltage in a plurality of pixel voltages and corresponding scan signal in a plurality of scan signals, the data line coupled to each pixel is different from the data line coupled to the adjacent pixels, and the driving method comprises following steps:
receiving a frame-displaying signal;
determining whether the frame-displaying signal divides the pixels into a plurality of groups to respectively display a first gray-level value and a second gray-level value by a timing controller of a display apparatus;
when the timing controller determines out the frame-displaying signal divides the pixels into a plurality of groups for respectively displaying a first gray-level value and a second gray-level value, the timing controller adjusts a plurality of enabling durations of the scan signals to control the pixels of each of the groups displaying the same luminance, wherein each of the groups comprises at least two of the pixels; and
when the timing controller determines out the frame-displaying signal does not divide the pixels into a plurality of groups for respectively displaying a first gray-level value and a second gray-level value, the timing controller adjusts the enabling durations of the scan signals into the enabling durations identical to each other.

10. The method as claimed in claim 9, wherein the pixel voltages are generated in a column inversion mode.

11. The method as claimed in claim 10, wherein the step of adjusting the enabling durations of the scan signals by the timing controller comprises:
when voltage level of the pixel voltages in a horizontal scanning duration is different from voltage level of the pixel voltages in the previous horizontal scanning duration, the timing controller elongates enabling duration corresponding to the horizontal scanning duration.

12. The method as claimed in claim 10, wherein the step of adjusting the enabling durations of the scan signals by the timing controller comprises:
when voltage level of the pixel voltages in a horizontal scanning duration is the same as voltage level of the pixel voltages in the previous horizontal scanning duration or the horizontal scanning duration is the first horizontal scanning duration of a frame duration, the scan driver controlled by the timing controller shortens enabling duration corresponding to the horizontal scanning duration.

13. The method as claimed in claim 9, wherein the first gray-level value and the second gray-level value are respectively a maximum gray-level value and a minimum gray-level value.

14. The method as claimed in claim 9, wherein pixel quantities and arrangements of the pixels respectively comprised by the groups are identical.

15. The method as claimed in claim 9, wherein when each of the groups displays the first gray-level value, the groups adjacent to the each of the groups display the second gray-level value.
